(19) United States
(12) Patent Application Publication
(10) Pub. No.: US 2023/0288116 A1
(43) Pub. Date: Sep. 14, 2023

(54) LARGE SCALE SYNTHESIS OF PHARMACEUTICAL AND BIOLOGIC FORMULATIONS USING THIN FILM FREEZING

(71) Applicant: TFF Pharmaceuticals, Inc., Austin, TX (US)

(72) Inventors: Donald E. OWENS, III, Austin, TX (US); John J. KOLENG, JR., Austin, TX (US)

(21) Appl. No.: 18/120,514

(22) Filed: Mar. 13, 2023

Related U.S. Application Data
(60) Provisional application No. 63/319,482, filed on Mar. 14, 2022.

(51) Int. Cl. F25C 1/14; F25B 9/00

(52) U.S. Cl. CPC F25C 1/14; F25B 9/002; F25C 2301/00

(57) ABSTRACT

The invention encompasses methods for the large-scale (preferably under cGMP or cGLP standards) preparation of micron-sized or submicron-sized particles including pharmaceutical or biologic active agents. The systems and methods include a cryogenic cooling system including a novel shroud that enhances the cooling effects thereby reducing product loss and increasing product yields.

### CROSS-REFERENCE TO RELATED APPLICATION

This application claims the benefit of and priority to U.S. provisional patent application No. 63/319,482, which was filed on Mar. 14, 2022, and is incorporated herein by reference in its entirety.

### FIELD OF THE INVENTION

The invention encompasses methods for large-scale (preferably under cGMP conditions) preparation of micron-sized or submicron-sized particles including active pharmaceutical ingredients and drug products. The systems and methods include a cryogenic cooling system including a shroud and cold nitrogen gas return plenum that enhances the cooling effects locally thereby reducing product loss and increasing product yields.

### BACKGROUND OF THE INVENTION

Without limiting the scope of the invention, this background is described in connection with systems and methods for the large-scale production of stable submicron sized particles of active pharmaceutical agents.

The ability to produce high-surface-area stable submicron and micron-sized particles creates opportunities including, but not limited to, oral, injectable, and pulmonary delivery applications. The stable submicron particles also have many specific advantages for pulmonary delivery. Although particles need to have an aerodynamic diameter between about 1 and about 3 μm for efficient deep lung delivery, the submicron particles can form porous nano-aggregated microparticles that can be effectively delivered to the lung. The highly porous aerosolized particles have advantages over dense micron-sized powders, including more rapid dissolution in the lung leading to increased long-term responses.

The invention relates to a thin film freezing (TFF) system and process for producing stable submicron particles. Droplets of aqueous and/or organic solutions and/or slurries containing an active agent optionally including one or more excipients are made to fall on a rotating stainless steel drum. The drum is hollow and filled with a cryogen. Upon impact, the droplets spread out into thin films that freeze in less than a second. The frozen films are removed continuously from the drum by a scraper blade mounted on the rotating drum surface and collected into containers that are then lyophilized.

In process-scale (e.g., large-scale) cryogenic synthesis under current Good Manufacturing Conditions (cGMP) challenges arise around the scale-up of the cGMP process as well as the steps for quality control and consistency of the final drug product. During the larger scale cryogenic synthesis in a cGMP environment it is critical to maintain a steady and subzero roller surface temperature, preferably below −50° C., while also preventing melting from occurring during ice collection, which can damage the final desired dry powder structure achieved after lyophilization.

The inventors have surprisingly discovered that the inclusion of a shroud covering all or at least a portion of the system allows for localized and controlled cooling of both the freezing drum as well as the ambient gas temperature within the shroud where drug product ice is accumulated. Additionally, the inventors further discovered that the inclusion of a gas plenum enables efficient usage and control of flow of cold gas across the frozen accumulated dig product to further ensure product quality and ice stability (e.g., no melt back of product).

### SUMMARY OF THE INVENTION

The invention encompasses systems and methods for a large-scale (e.g., commercial quality) thin film freezing process for the production of active agents or compositions comprising active agents with increased yield, reduced contamination, and improved safety. The large-scale methods (e.g., cGMP or cGLP quality standards) provide an efficient and robust process for freezing commercial scale quantities of an active agent followed by lyophilization or sublimation to form a dry powder formulation in the form of stable micron and submicron sized particles.

Generally, the invention encompasses a system for thin film freezing of an active pharmaceutical ingredient including a freezing roller drum assembly comprising: (1) a freeze cylinder assembly; (2) a scraper assembly; (3) a frame assembly; (4) a motor assembly; and (5) a manifold assembly, wherein the freezing cylinder assembly is maintained at a steady sub-zero degree Celsius temperature that freezes the drug product.

In certain embodiments, the system further comprises a shroud optionally covering the entire system assemblies or at least a portion of each of assemblies (1)-(5). The inventors have surprisingly found that the shroud: (i) allows the localized cool liquid N₂ environment to maintain a steady sub-zero temperature and low moisture environment; (ii) enables safer operation of the cryogenic freezing equipment; (iii) improves final product quality by reducing the occurrence of ice melt back; and (iii) reduces inadvertent contamination by bioburden (e.g., bacteria) or airborne particulates including viable and non-viable particulates.

In certain embodiments, the freezing cylinder assembly is maintained at a steady sub-zero degree Celsius temperature using a cryogenic source.

In certain embodiments, the cryogenic source is a cryogenic solid, a cryogenic gas, a cryogenic liquid, or a heat transfer fluid capable of reaching cryogenic temperatures.

In certain embodiments, the system further comprises at least one gas plenum to allow a cryogenic liquid, a cryogenic gas, or the heat transfer fluid to recirculate throughout the system.

In certain embodiments, the system further includes a filter or filtration system to filter a cryogenic source entering the shroud to remove bioburden and/or particulate matter including viable and non-viable particulates from entering the system.

In certain embodiments, the cryogenic solid, cryogenic gas, cryogenic liquid, or heat transfer fluid is capable of reaching temperatures below −50° C., preferably below −70° C., more preferably below −100° C. In certain embodiments, the cryogenic source contacts the freezing cylinder assembly to maintain a steady sub-zero degree Celsius temperature. In certain embodiments, the cryogenic liquid contacts the freezing cylinder assembly to maintain a steady sub-zero degree Celsius temperature. In certain embodiments, the system further comprises a heat exchanger to maintain the steady sub-zero degree Celsius temperature.

In certain embodiments, the cryogenic liquid is an inert liquid or gas. In certain embodiments, the inert liquid or gas is liquid nitrogen or liquid argon.

In certain embodiments, the cryogenic solid is dry ice.

In certain embodiments, the active agent includes a small molecule active agent or biologic active agent.

In certain embodiments, the system is included within an enclosure.

In other embodiments, the invention encompasses a system for large scale, thin film freezing of a drug product comprising: (i) a freezing roller drum assembly comprising: (1) a freeze cylinder assembly; (2) a scraper assembly; (3) a frame assembly; (4) a motor assembly; (5) a manifold assembly; and (6) a shroud covering at least a portion of each of assemblies (1)-(5), wherein the freezing cylinder assembly is maintained at a steady sub-zero degree Celsius temperature that freezes the active agent.

In certain embodiments, the freezing cylinder assembly is maintained at a steady sub-zero degree Celsius temperature using a cryogenic source.

In certain embodiments, the system further comprises at least one gas plenum to allow a cryogenic source to recirculate in the system.

In certain embodiments, the system further includes a filter or filtration system to filter a cryogenic source entering the shroud to remove bioburden and/or particulate matter including viable and non-viable particulates from entering the system.

In certain embodiments, the cryogenic source is a cryogenic solid, a cryogenic gas, a cryogenic liquid, or a heat transfer fluid capable of reaching cryogenic temperatures.

In certain embodiments, the cryogenic source contacts the freezing cylinder assembly to maintain a steady sub-zero degree Celsius temperature. In certain embodiments, the cryogenic solid, cryogenic gas, cryogenic liquid, or heat transfer fluid is capable of reaching temperatures below −50° C., preferably below −70° C., more preferably below −100° C.

In certain embodiments, a cryogenic liquid contacts the freezing cylinder assembly to maintain a steady sub-zero degree Celsius temperature. In certain embodiments, the cryogenic liquid is an inert liquid gas. In certain embodiments, the inert liquid gas is liquid nitrogen or liquid argon.

In certain embodiments, the cryogenic solid is dry ice.

In certain embodiments, the active agent includes a small molecule active agent or biologic agent. In certain embodiments, the active agent is dissolved in an aqueous or organic solvent or pharmaceutically acceptable carrier.

In certain embodiments, the system is included within an enclosure.

In another embodiment, the invention encompasses a method for large scale thin film freezing formation of an active agent comprising: (a) utilizing the systems disclosed herein, the method comprising: (i) cooling a solid surface of a freeze cylinder assembly to less than −70° C.; (ii) dissolving or dispersing an active agent into a solution; (iii) contacting the solution with the cold solid surface of the freeze cylinder assembly so as to freeze the solution.

In certain embodiments, the cold surface is cooled using a cryogenic source.

In certain embodiments, the cryogenic source is a cryogenic solid, a cryogenic gas, a cryogenic liquid or a heat transfer fluid capable of reaching cryogenic temperatures.

In certain embodiments, the system further comprises a shroud covering at least a portion of each of assemblies (1)-(5).

In certain embodiments, the freezing cylinder assembly is maintained at a steady sub-zero degree Celsius temperature, preferably below −50° C., using a cryogenic source.

In certain embodiments, the system further comprises at least one gas plenum, to allow a cryogenic liquid, a cryogenic gas, or the heat transfer fluid to circulate in the system.

In certain embodiments, the system further includes a filter or filtration system to filter a cryogenic source entering the shroud to remove bioburden and/or particulate matter including viable and non-viable particulates from entering the system.

In certain embodiments, the cryogenic solid, cryogenic gas, cryogenic liquid, or heat transfer fluid is capable of reaching temperatures below −50° C., preferably below −70° C., more preferably below −100° C.

In certain embodiments, the cryogenic source contacts the freezing cylinder assembly to maintain a steady sub-zero degree Celsius temperature.

In certain embodiments, the cryogenic liquid contacts the freezing cylinder assembly to maintain a steady sub-zero degree Celsius temperature. In certain embodiments, the system further comprises a heat exchanger to maintain the steady sub-zero degree Celsius temperature.

In certain embodiments, the cryogenic liquid is an inert liquid gas. In certain embodiments, the inert liquid gas is liquid nitrogen or liquid argon.

In certain embodiments, the cryogenic solid is dry ice.

In certain embodiments, the composition or active agent includes a small molecule active agent or biologic active agent.

In certain embodiments, the system is included within an enclosure.

In a separate step solvent can be removed, for example, by sublimation or lyophilization.

In certain embodiments, the resulting particles have a mean volume average particle size from less than 0.05 microns to 25 microns.

In certain embodiments, the resulting particles have a surface area of at least 2 m²/g, at least 4 m²/g, at least 6 m²/g, at least 8 m²/g, or at least 10 m²/g.

In certain embodiments, the resulting particles exhibit an in vitro dissolution rate of at least 1.5 times better, 2 times better, 2.5 times better, 3 times better, 3.5 times better, 4 times better, 4.5 times better, or 5 times better than that of the unprocessed active agent or drug product.

In certain embodiments, the cold surface is cooled using a cryogenic solid, a cryogenic gas, a cryogenic liquid or a heat transfer fluid capable of reaching cryogenic temperatures.

In certain embodiments, the aqueous or organic solvent includes, but is not limited to water, alcohols, ethers, halocarbons, hydrocarbons, halogenated hydrocarbons, aromatic hydrocarbons, esters, acetates, organic acids, amines, ketones, sulfones, nitriles, carbonates, and combinations thereof.

In certain embodiments, the mean volume average particle size of the particles after the particles are dispersed in water is from about 0.05 microns to about 150 microns.

In certain embodiments, the solution further comprises at least one stabilizer.

In certain embodiments, the stabilizer is selected from the group consisting of phospholipids, surfactants, polymeric surfactants, vesicles, polymers selected from copolymers, homopolymers and block polymers, dispersion aids, and combinations thereof.

In certain embodiments, the solvent is removed using lyophilization, sublimation or evaporation.

In certain embodiments, the invention encompasses using a closed system in which an active agent is dissolved and/or dispersed in one or more solvents; spraying or dripping droplets of the solvent including the dissolved and/or dispersed biologic or pharmaceutical agent such that the active ingredient is exposed to a vapor-liquid interface of less than about 50, 100, 150, 200, 250, 200, 400 or 500 cm⁻¹ area/volume to, for example, increase stability; and contacting the droplet with a freezing surface that has a temperature differential of at least 30° C. between the droplet and the surface, wherein the surface freezes the droplet into a thin film with a thickness of less than about 500 micrometers and a surface area to volume between about 25 to about 500 cm⁻¹.

In certain embodiments, the large-scale systems and methods for thin film freezing improve the physicochemical properties of the active agents, thereby enhancing the bioavailability by generating, for example, amorphous nanostructured aggregates with significantly enlarged surface area, higher dissolution rates, and supersaturation, via rapidly inducing nucleation followed by particle growth arrest through stabilization via polymers and solidification of the solvent.

In certain embodiments, the large scale system and methods to cryogenically cool active agents result in improved in vitro and in vivo macroscopic performance.

In another embodiment, the invention encompasses a large scale cryogenic system for thin film freezing of active agents using a freezing roller drum assembly (See FIG. 1 and FIG. 2) optionally included within an enclosure, wherein the freezing roller drum assembly includes a shroud that covers a portion or the entirety of the freezing roller drum assembly system, wherein inclusion of the shroud system surprisingly and unexpectedly improves purity, yield, and safety due a much colder and drier (i.e. desiccated) processing environment than would otherwise be present as well as the containment of oxygen displacing gases. In various embodiments, the shroud prevents ice from accumulating on the drum from moisture present in standard cGMP air which would decrease the freezing rate of the process. Additionally, the shroud avoids melt back after freezing by ensuring a steady sub-zero temperature locally near the freezing roller assembly and ice collector.

In certain embodiments, the present invention encompasses systems and methods for large scale thin film freezing manufacture of dry powder formulations of active agents, wherein the system comprises a shroud.

In various embodiments, the systems and methods of the invention including the shroud provide the following surprising and unexpected results:
a. The shroud maintains the internal environment such that when liquid nitrogen evaporates, it desiccates the internal atmosphere within the closed system to prevent ice formation on the roller;
b. The shroud allows the localized cool liquid and evolved gaseous N₂ environment to maintain a steady sub-zero ambient air temperature to prevent ice product melt-back, which would destroy the final powder nanostructured properties;
c. The shroud also provides increased robustness in the operating environment and allows for the safe collection and venting of off-gassing N₂; and
d. The shroud reduces particulate loss of the final dry powder formulation and prevents inadvertent inhalation by workers, and avoids the inadvertent contamination by airborne particulates.

In various embodiments, the shroud is constructed of, for example, aluminum, polymer, plastic, or stainless steel or a combination thereof.

In certain embodiments, the cryogenic system includes a freeze zone adjacent to and including the freeze cylinder assembly. In certain embodiments, the cryogenic system is cooled preferably using liquid nitrogen or another suitable freezing agent (e.g., liquid argon and traditional refrigerants). In certain embodiments, the cryogenic system is cooled preferably using refrigerants including chlorofluorocarbons, hydrochlorofluorocarbons, and hydrofluorocarbons. In certain embodiments, the system also includes a collection tray that includes or is cooled by ice chips, preferably dry ice (i.e., frozen CO₂), or other appropriate cryogenic materials. In certain embodiments, the dry ice chips do not come in contact with the thin film freezing collected product. In certain embodiments, the cryogenic system maintains a steady state temperature within about ±10° C. In other embodiments, the cryogenic system maintains a constant temperature within about ±2° C. In certain embodiments, the shroud is double-paned with a space between the panes to increase the insulation and the steady temperature of the system.

In certain embodiments, the system is included in an enclosure. In other embodiments, the enclosure includes at least one conveyor and to move product through the system. The film freezing system and shroud system also optionally includes at least one sensor positioned on the shroud and configured to detect, for example, temperature, pressure, and/or amount of product on the freeze cylinder assembly or the collection assembly.

In certain embodiments, a conveyor included in the enclosure is configured to move the system linearly in response to a detection by at least one sensor. The enclosure may further include at least one track, wherein the at least one linear conveyor is enclosed within the at least one track, for example, to allow transfer of the produced product within the enclosure.

In certain embodiments, the freezing roller drum assembly includes a constant injection of liquid coolant into a freeze zone of the system. In certain embodiments, the liquid coolant is liquid argon or liquid nitrogen. In certain embodiments, the liquid coolant is liquid nitrogen.

In certain embodiments, the liquid nitrogen may be pressurized or under vacuum to eliminate flow disruption due to volume expansion.

In certain embodiments, the shroud assembly of the freezing roller drum assembly system allows the isolation of the inlet (e.g., coolant supply inlet) tube so that the liquid nitrogen will arrive at the freezing roller drum assembly and collection tray at a temperature below −90° C. In certain embodiments, the shroud assembly also prevents or minimizes the liquid flow from forming gaseous bubbles, so as not to create a vapor lock condition that limits the cooling power. In certain embodiments, the system operates near the critical point of the liquid-vapor system so that the vapor phase is denser than it would be if operated near atmospheric pressures. This makes the volume expansion of the liquid into the vapor phase much less, and it makes the resulting vapor phase a much more effective coolant.

In certain embodiments, the cryogenic thin film freezing method includes initial cooling to cool the system including the collection assembly and freeze cylinder assembly and related parts of the system to be cooled from room temperature using liquid nitrogen to the target cooling temperature when the system is activated. The collection assembly included within the system is cooled with dry ice chips and then the entire system is further cooled using liquid nitrogen.

### BRIEF DESCRIPTION OF THE FIGURES

Hereinafter, embodiments for carrying out the present invention will be described in detail with reference to the drawings. In the description and drawings, the same or equivalent components, members, and processing are designated by the same reference signs, and redundant description will be appropriately omitted. The scales and shapes of the respective parts illustrated in the figures are set for the sake of convenience for facilitating description, and should not be interpreted as limiting unless otherwise specified. The embodiments are examples and does not limit the scope of the present invention. All the features and combinations described in the embodiments are not necessarily essential to the invention.

FIG. 1 illustrates the freezing roller assembly with the shroud and manifold removed.

FIG. 2 illustrates the freezing roller assembly with the shroud covering the roller assembly and manifold added on top of the shroud.

FIG. 3. an external side view showing the motor assembly the rotates the drum as well as the manifold assembly which is sitting on top of the shroud.

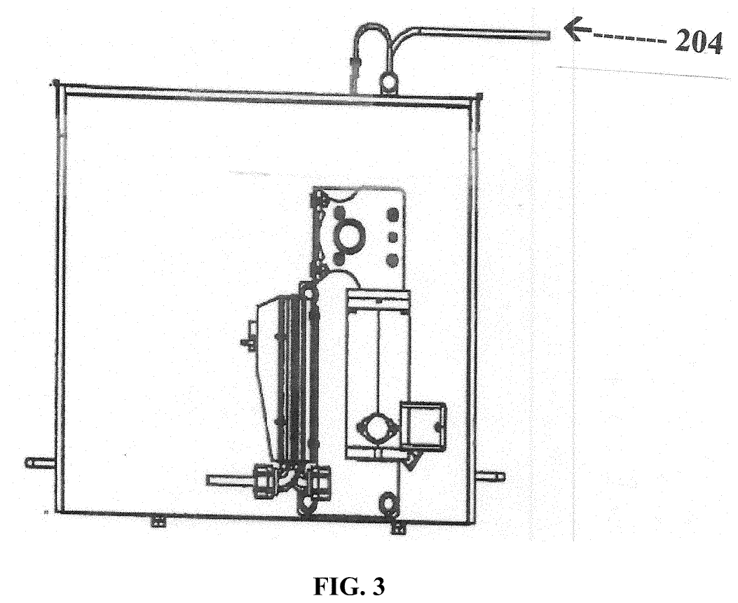

FIG. 4 illustrates an external back view of the freezing roller assembly within the shroud and with the manifold placed on top of the shroud.

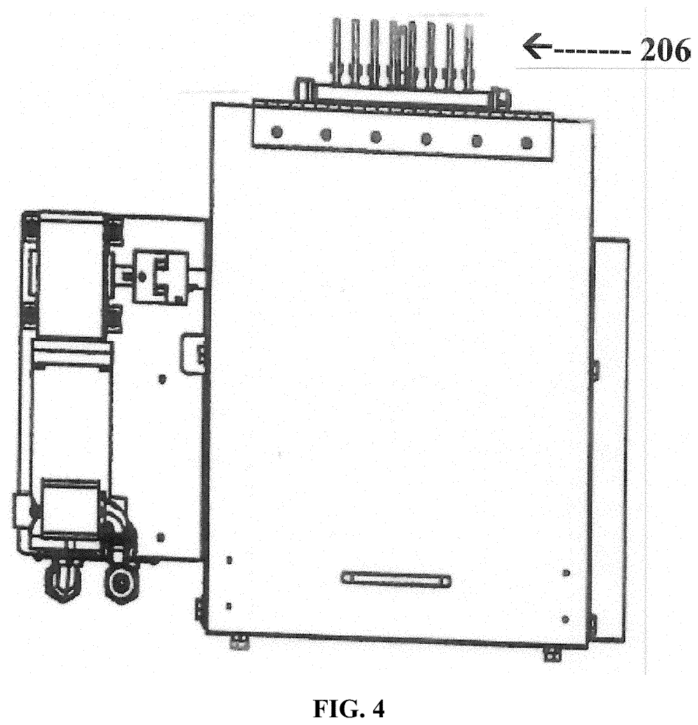

FIG. 5 illustrates a side view of the freezing roller assembly shroud showing the liquid nitrogen inlets and exhaust ports and well as the product inlet to the manifold on top of the shroud.

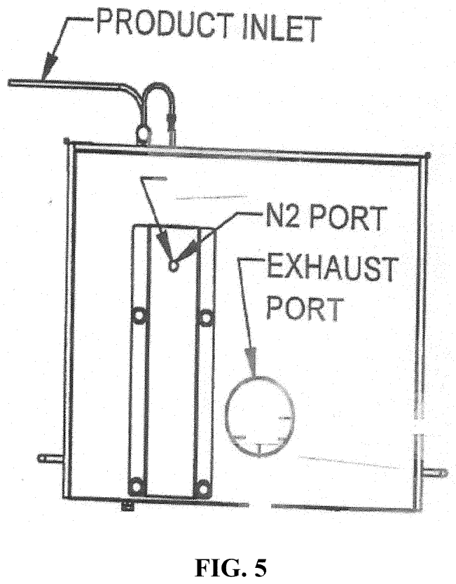

### DETAILED DESCRIPTION OF THE INVENTION

For a more complete understanding of the features and advantages of the present invention, reference is now made to the detailed description of the invention along with the examples and claims.

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention.

Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the terms “a,” “an,” or “a(n)”, is an indefinite article when used in reference to a group of substituents or “substituent group” herein, mean at least one.

As used herein, the term “about” when referring to a value includes the stated value +/−10% of the stated value. For example, about 50% includes a range of from 45% to 55%, while about 20 molar equivalents includes a range of from 18 to 22 molar equivalents. Accordingly, when referring to a range, “about” refers to each of the stated values +/−10% of the stated value of each end of the range. For instance, a ratio of from about 1 to about 3 (weight/weight) includes a range of from 0.9 to 3.3.

As used herein, the term “active pharmaceutical ingredient,” “active agent,” and “drug product” are used interchangeably and refer to a substance that can used in a finished pharmaceutical product (FPP), intended to furnish pharmacological activity or to otherwise have direct effect in the diagnosis, cure, mitigation, treatment or prevention of disease, or to have direct effect in restoring, correcting or modifying physiological functions in human beings. The “active pharmaceutical ingredient,” “active agent,” and “drug product” may be a small molecule (e.g., a cannabinoid, antibiotic, or antifungal) or biologic (e.g., a protein, antibody, or mRNA) and can be used alone in the methods of compositions of the invention or may be included in an aqueous or organic solvent or a pharmaceutically acceptable carrier. Exemplary, non-limiting examples of “active pharmaceutical ingredients,” “active agents,” and “drug products” that may be used in the embodiments of the invention include, but are not limited to, nucleic acids, RNA (including siRNA, mRNA, microRNA, ncRNA), DNA (including pDNA), a DNase, peptides, proteins, fAbs, mAbs, phages, adeno-associated virus, virus like particles, bacterium, virus fragments, activated virus, lentivirus, recombinant vesicular stomatitis virus, α-1-antitrypsin, interleukin, protease inhibitor, an interleukin receptor, a monoclonal antibody, a muramyl dipeptide, a catalase, a phosphatase, a kinase, a receptor antagonist, a receptor agonist, a dismutase, a calcitonin, a hormone, an interferon, insulin, a growth factor, erythropoietin, heparin, vasopressin, peptides, albuterol sulfate, terbutaline sulfate, insulin, glucagon-like peptide, C-Peptide, erythropoietin, calcitonin, human growth hormone, luteinizing hormone, prolactin, sugars, lipids, amino acids, fatty acids, phenolic compounds, alkaloids, adrenocorticotropic hormone, leuprolide, interferon α-2b, interferon beta-1a, sargramostim, aldesleukin, interferon α-2a, interferon alpha, n3 α-peptide or proteinase inhibitor; etidronate, nafarelin, chorionic gonadotropin, prostaglandin E2, epoprostenol, acarbose, metformin, or desmopressin, cyclodextrin, cannabinoids, plant extracts, antibiotics, gene therapy agents, catalysts, adsorbents, pigments, coatings, personal care products, abrasives, particles for sensors, metals, alloys, ceramics, membrane materials, nutritional substances, anti-cancer agents, as well as, antibiotics, analgesics, anticonvulsants; antidiabetic agents, antifungal agents, antineoplastic agents, antiparkinsonian agents, antirheumatic agents, appetite suppressants, biological response modifiers, cardiovascular agents, central nervous system stimulants, contraceptive agents, diagnostic agents, dopamine receptor agonists, erectile dysfunction agents, fertility agents, gastrointestinal agents, hormones, immunomodulators, anti-hypercalcemia agents, mast cell stabilizers, muscle relaxants, nutritional agents, ophthalmic agents, osteoporosis agents, psychotherapeutic agents, parasympathomimetic agents, parasympatholytic agents, respiratory agents, sedative hypnotic agents, skin and mucous membrane agents, smoking cessation agents, steroids, sympatholytic agents, urinary tract agents, uterine relaxants, vaginal agents, vasodilator, antihypertensive, hyperthyroid, anti-hyperthyroids, anti-asthmatics, vertigo agents, cardiovascular drug, respiratory drug, sympathomimetic drug, cholinomimetic drug, adrenergic or adrenergic neuron blocking drug, antidepressant, antihypertensive agent, anti-inflammatory, antianxiety agent, immunosuppressive agents, antimigraine agents, sedatives/hypnotic, antianginal agents, antipsychotic agents, antimanic agents, antiarrhythmic, antiarthritic agent, antigout agents, anticoagulant, thrombolytic agents, antifibrinolytic agents, hemorheological agents, antiplatelet agents, anticonvulsant, antihistamine/antipruritic, agent useful for calcium regulation, antiviral agents, anti-infective, bronchodilator, hormone, hypoglycemic agent, hypolipidemic agent, protein, nucleic acid, agent useful for erythropoiesis stimulation, antiulcer/antireflux agent, antinauseant/antiemetic, oil-soluble vitamin, mitotane, visadine, halonitrosourea, anthracycline, voriconazole, tacrolimus, remdesivir, or ellipticine. It will be appreciated that this list is not exhaustive and is for demonstrative purposes only. It will be further appreciated that it is possible for one compound to be included in more than one class of active agents, for example, peptides and proteins.

As used herein, the term “administering” refers to administration of the composition of the present invention to a subject.

As used herein, “bioavailability” is a term meaning the degree to which a drug becomes available to the target tissue after being administered to the body. Poor bioavailability is a significant problem encountered in the development of pharmaceutical compositions, particularly those containing an active ingredient that is not highly soluble in water. In certain embodiments, the active agent may be water soluble, poorly soluble, not highly soluble or not soluble. The skilled artisan will recognize that various methodologies may be used to increase the solubility of the active agents (e.g., use of different solvents, excipients, carriers, glycosylation, lipidation, degradation, combination with one or more salts and the addition of various salts).

As used herein, the term “carrier” refers to any liquid that an active agent or composition can be included in the processes of the invention. For example, an active agent or composition may be dissolved or dispersed in a liquid carrier, but the active agent or composition is not required to be dissolved in the carrier.

As used herein, the term “composition” as used herein is intended to encompass a product that includes one or more active pharmaceutical ingredients or active agents, or drug products, and optionally one or more pharmaceutically acceptable excipients, carriers or diluents as described herein, such as in specified amounts defined throughout the originally filed disclosure, which results from combination of specific components, such as specified ingredients in the specified amounts as described herein.

As used herein, the term “cryogenic” means the system or process is maintained for a period of time (e.g., 1, 5, 15, 30, 60 minutes, or 1, 2, 3, 4, 5, 6, etc. hours) at a very low temperature, for example, a temperature of less than about −50° C. For example, a cryogenic source is a source that can initiate and/or maintain a temperature of at least −50° C. or lower.

As used herein, the term “fine particle fraction” is defined to mean is the portion of the delivered material (i.e., a formulation that contains respirable aggregates and particles, either drops, dry powder, or the like) that actually is delivered to the lung. The fine particle fraction depends not only upon the performance of the particles and respirable aggregates, but also on the performance of the delivery device. This fine particle fraction will generally comprise respirable aggregates having a mass median aerodynamic diameter of between about 1 and about 5 m. This is the desired size for the drops that are delivered for a nebulizer or pressurized metered dose inhaler (pMDI), or dry powder for a dry powder inhaler (DPI), such drops or powder comprising the aggregates and particles.

As used herein, the term “heat exchanger” means a system or component of a system used to transfer heat from one medium to another. These media may be a gas, liquid, or a combination of both. The heat exchanger of the invention may optionally include a compressor/condenser, piping, and a circulated fluid or gas.

As used herein, the term “inert” refers to a substance that when contacted with another substance causes no chemical reaction or change. For example, an inert gas or inert liquified gas if contacted with the active agent or active pharmaceutical ingredient of the invention causes no chemical reaction between the inert gas or inert liquified gas and the active agent or active pharmaceutical ingredient.

As used herein, the term “large-scale” refers to a thin film freezing method described herein using an amount of active agent from about 0.1 kg to about 25 kg. In certain embodiments, “large scale” means about 0.1 kg, 0.5, 1, 1.5, 2, 2.5, 3, 3.5, 4, 4.5, 5, 5.5, 6, 6.5, 7, 7.5, 8, 8.5, 9, 9.5, 10, 15, 20, 25 or more kg of active agent.

As used herein, the term “maintained” means to keep about the same for a period of time (e.g., about 1, 5, 15, 30, 60 minutes, or 1, 2, 3, 4, 5, 6, etc. hours). For example, maintained at a temperature below −50° C. means the temperature is kept below about −50° C. for a period of time including, but not limited to, about 1, 2, 3, 4, 5, 6, 7, 8, 9, 10, 11, 12, 13, 14, 15, 20, 25, 30, 35, 40, 45, 50, 55, or 60 minutes or 1, 2, 3, 4, 5, 6, 8, 10, 12, 24 hours or all time intervals in between.

As used herein the term “particle” is used to describe a particle comprising an active agent, such active agents being described below in more detail. The particles form individual units within a respirable aggregate, such that the respirable aggregate comprises one or more particles comprising the active agent, dispersed throughout the respirable aggregate.

As used herein the term “respirable aggregate” is used to describe an aggregate of one or more particles, the aggregate having a surface area (when in dry form) of greater than 1 m²/g. More preferably, the surface area of the respirable aggregate is greater than about 5 m²/g, even more preferably greater than about 10 m²/g, and yet even more preferably greater than about 20 m²/g. A respirable aggregate may also comprise smaller engineered active agent particles, each active agent particle having a particle size of less than about 1 m. A respirable aggregate may be, for example a dry powder or a dry powder dispersed in liquid, forming one or more droplets. The respirable aggregates of the present invention are also easily wettable, as demonstrated by contact angle measurements for disks formed by pressing the respirable aggregates into tablet form. Such contact angle measurements are less than about 50 degrees, preferably less than 40 degrees, more preferably less than about 30 degrees, and even more preferably less than 20 degrees. Furthermore, the respirable aggregates of the present invention, when dry, have a porosity of at least about 10 percent, more preferably at least 25 percent, even more preferably at least about 40%, still more preferably at least 60% and up to about 80%. The respirable aggregates of the present invention demonstrate a density of from about 0.1 g/mL to about 5 g/mL.

As used herein, the terms “therapeutically effective amount” or “effective amount” refers to an amount of an active pharmaceutical ingredient, active agent or drug product useful for treating or ameliorating an identified disease or condition, or for exhibiting a detectable therapeutic or inhibitory effect. “Therapeutically effective amount” or “effective amount” further includes within its meaning a non-toxic but sufficient amount of the particular drug to which it is referring to provide the desired therapeutic effect. The exact amount required will vary from subject to subject depending on factors such as the subject's general health, the patient's age, etc. The exact amounts will depend on the purpose of the treatment, and will be ascertainable by one skilled in the art using known techniques (see, e.g., Lieberman, Pharmaceutical Dosage Forms (vols. 1-3, 1992); Lloyd, The Art, Science and Technology of Pharmaceutical Compounding (1999); Pickar, Dosage Calculations (1999); and Remington: The Science and Practice of Pharmacy, 20th Edition, 2003, Gennaro, Ed., Lippincott, Williams & Wilkins).

As used herein, the terms “treat”, “treating” and “treatment” refer to any indicia of success in the treatment or amelioration of an injury, pathology or condition, including any objective or subjective parameter such as abatement; remission; diminishing of symptoms or making the injury, pathology or condition more tolerable to the patient; slowing in the rate of degeneration or decline; making the final point of degeneration less debilitating; improving a patient's physical or mental well-being. The treatment or amelioration of symptoms can be based on objective or subjective parameters; including the results of a physical examination, neuropsychiatric exams, and/or a psychiatric evaluation.

The term “viable and non-viable particulates” refers to living particulates (e.g., bacteria sometimes referred to as bioburden) and non-living particulates (e.g., dust or other non-living matter that may be airborne).

The abbreviation, “(w/w)” refers to the phrase “weight for weight”, i.e., the proportion of a particular substance within a mixture, as measured by weight or mass or a weight amount of a component of the composition disclosed herein relative to the total weight amount of the composition. Accordingly, the quantity is unit less and represents a weight percentage amount of a component relative to the total weight of the composition. For example, a 2% (w/w) solution means 2 grams of solute is dissolved in 100 grams of solution.

### General Description of the Embodiments

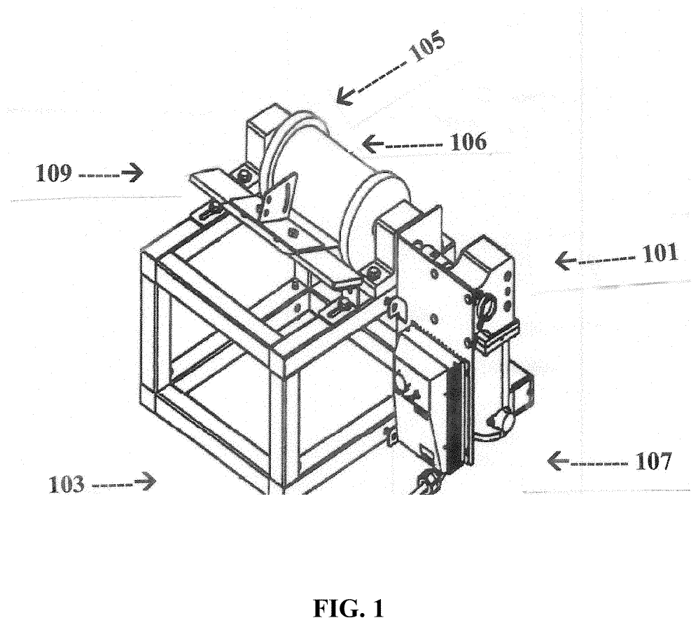

The invention encompasses systems and methods for a large-scale (e.g., commercial cGMP quality) thin film freezing process of active pharmaceutical ingredients, active agents, and drug product with increased yield, reduced contamination, and improved safety. The large-scale (e.g., cGMP quality) methods provides an efficient and robust process for freezing commercial scale quantities of a dry powder formulation that can produce stable submicron sized particles (e.g., μm or nm size particles). The system and methods can optionally be conducted in a closed enclosure system to house the freezing roller drum assembly for the preparation of thin film freezing of active agents ultimately resulting in micron and submicron size particles. An enclosure can include a plurality of inlets and exhaust ports including one or more compressed or blown liquid nitrogen gas inlets, which can be controlled by one or more regulator valves to maintain a steady state internal temperature and pressure. Each of the inlets and exhaust ports allows the flow of cryogenic gas or liquid to pass through an optional high flow filter to remove particulate matter. The gas can then optionally be directed through a dehumidifier to produce a stable dry atmosphere. The gas can then be directed through an initial flow valve proximal to the freezing roller drum assembly (See FIG. 1), which controls the volume and velocity of liquid nitrogen to the freezing assembly. After leaving the enclosure assembly, the gas stream passes into ambient atmosphere or through a control valve to a vacuum fan with volume and velocity of the exhaust flow controlled by the post-freezing assembly valve. A vacuum hose may serve as a connection between the freezing assembly and the vacuum flow valve.

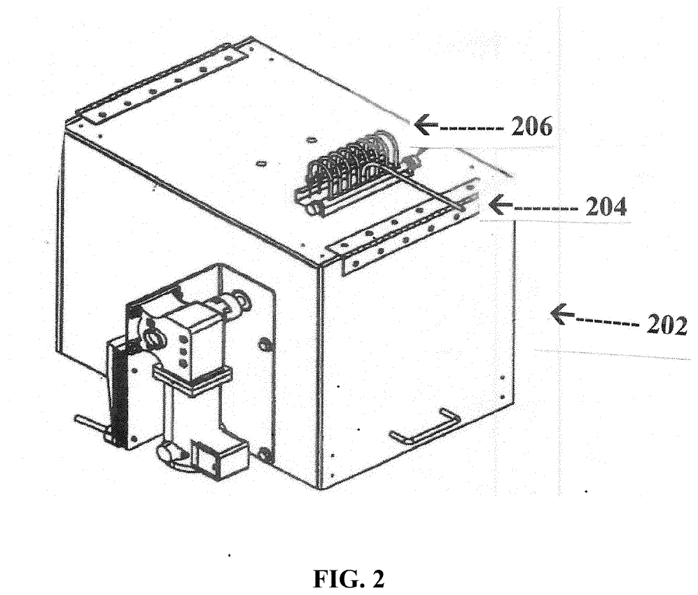

The freezing roller drum assembly (101) is illustrated in FIG. 1. The manifold assembly includes a product inlet (204, FIG. 2) that branches out into one or a plurality of droplet orifices (206). This droplet stream is then directed onto a freezing section of the freezing roller drum assembly (105), which contains a solid cryogenically cooled surface, where the droplets are frozen upon contact.

Each of the components located proximal to the freezing roller drum assembly (101), or distal to the freezing roller drum assembly are optional. For instance, the freezing assembly (101) can be attached directly to a liquid nitrogen source without use of a high flow filter, dehumidifier, or control valve, and without the use of any components beyond the freezing roller drum assembly (101). Alternately, the assembly can be included within an enclosure and optionally include a flow filter, dehumidifier, or control valve can be added to the enclosure in any combination with the freezing roller drum assembly.

One of the advantages of the enclosure of the invention is that most embodiments are relatively inexpensive to assemble. The tubing, piping, and or hose pieces used to construct each section may be made out of many different materials including: metal, plastic, glass, rubber, and other similar substances which would be sufficient to contain liquids and gasses at low temperatures.

In certain embodiments, a gas pressure gradient is applied across the enclosure, with high gas pressure at the proximal end of the enclosure, low gas pressure at the distal end of the enclosure, and the ambient air pressure typically between the pressure gradient values. Preferably the cooling gas used for this system is liquid nitrogen. The gas may flow into the freezing roller drum assembly through a pressurized gas hose coupled to the assembly with a hose coupling. Coupling the hose to the assembly may be accomplished by various methods including simply sliding the hose over the assembly allowing friction to keep the hose in place, placing a simple clamp over the hose to further secure it into place, or even adding a sticky substance between the hose and the assembly. In general, any means which would keep the hose in place to avoid gas leaking out between the hose and the assembly would be sufficient for the hose coupling. In one embodiment of the invention, the pressurized gas hose is water vapor saturated.

In some embodiments, the thin film freezing system and method is not included in an enclosure. Generally, the freezing roller drum assembly includes: (1) a freeze cylinder assembly (105), (2) a scraper assembly (109), (3) a frame assembly (103), (4) a motor assembly (107), (5) a manifold assembly (206), and (6) a shroud (202) covering all or a portion of assemblies 1-5.

The freeze cylinder assembly is initially brought to a temperature below about −50° C. using, for example, liquid nitrogen. In various embodiments, the temperature is below about 0° C., typically below about −50° C., below about −70° C., below about −90° C., below about −110° C., or below about −130° C.

Once the freeze cylinder assembly (105) including a cryogenic cylinder (106) are cooled to the desired temperature, droplets of solvent including an active agent pass through the product inlet (204) and are slowly dropped from the manifold through a series of exit orifices (206) onto the cryogenic surface (106) of the freeze cylinder assembly (105), for example, a frozen metal surface. Other cryogenic surfaces may include metallic, ceramic, polymer, or plastic surfaces or combinations thereof. The temperature of the cryogenic surface of the freezer cylinder assembly is maintained at steady temperature using liquid nitrogen, liquid argon, other liquified or slush cryogenic gases, or other appropriate heat transfer fluids. The sample droplets including active agent are rapidly frozen upon contact with the cryogenic surface (106) of the freezing roller drum assembly (105), and then are collected in the form of frozen flakes or droplets from the surface using a scraper assembly (109).

### Freezing Roller Drum Assembly Sections

Embodiments of the individual sections of the freezing roller drum assembly (101) will be discussed in greater detail in the following paragraphs. In various embodiments, the freezing roller drum assembly generally includes: (1) a freeze cylinder assembly (105) including a cryogenic cylinder (106), (2) a scraper assembly (109), (3) a frame assembly (103), (4) a motor assembly (107), (5) a manifold assembly (206), and (6) a shroud (202) covering all or a portion of assemblies 1-5. In certain embodiments, the freeze roller drum assembly is located, for example, within an enclosure system. In other embodiments, the freeze roller drum assembly is a stand-alone system that is not in an enclosure system.

### Freezing Roller Drum Assembly

An embodiment of the freezing roller drum assembly (101) is illustrated in FIG. 1. The freezing roller drum assembly (101) includes a freeze cylinder assembly (105), which includes a cryogenic cylinder (106), a scraper assembly (109), the frame assembly (103), the enclosure assembly (See FIG. 2, (202)), and the motor assembly (107). In various embodiments, an active agent is dripped onto the freeze cylinder assembly (105), specifically onto the cryogenic cylinder (106), which causes the active agent to freeze quickly. The scraper (109) then removes the active agent from the freeze cylinder assembly, and the active agent is the collected in a collection tray or other appropriate container. The collection container s maintained at constant temperature, preferably using dry ice or another cooling method to maintain a low temperature.

In certain embodiments, the freezing roller drum assembly includes a shroud (202) that maintains the internal atmosphere and the freeze cylinder assembly (105) at constant temperature. The shroud assembly is illustrated in FIG. 2. The shroud assembly is designed to maintain steady temperature from the liquid nitrogen gas flow from the inlet in the direction of the freeze cylinder assembly until the gas exits into the exhaust port of the shroud. The inventors have surprisingly discovered that the inclusion of a shroud system allows for localized and controlled cooling of the freezing drum as well as the ambient air temperature within the shroud where drug product ice is accumulated. Additionally, the inventors further discovered that the inclusion of a gas plenum enables efficient usage and control of flow of cold nitrogen gas across the frozen accumulated drug product to further ensure product quality and ice stability (e.g., no melt back of product).

### Droplet Freezing Section—Freeze Cylinder Assembly

In one embodiment, a droplet of solvent including an active agent enters the freezing roller assembly through a product inlet tubing in the manifold assembly (206).

An embodiment of the freeze cylinder assembly (105, without the shroud) is illustrated in FIG. 1. The primary function of this section is to provide a surface area on the cryogenic freeze cylinder (106) for the droplet of active agent to immediately freeze. A shroud over the assembly (See FIG. 2) serves the purpose of maintaining a constant temperature with a secondary function of control of the direction of the liquid nitrogen stream and its subsequent flow in and around the freeze cylinder assembly (101). In the certain embodiments, the temperature is maintained using frozen cryogenic gas (for instance liquid nitrogen or argon). The solvent with active agent enters the top of the manifold assembly through a product inlet (204), and the solvent is dropped through one or more exit orifices (206) connected to the product inlet so the droplet immediately freezes on the cryogenic surface of the freeze cylinder assembly (105).

The freeze cylinder assembly (105) is illustrated in FIG. 1. In this particular embodiment, a frozen cryogenic gas (for example liquid nitrogen) flows in a central cylinder of the freeze cylinder assembly (105) in order to maintain the low temperature of the cylinder (106). Droplets enter the product inlet (204) and then flow through the manifold assembly (206) through the plurality of product exit orifices and then impact the cryogenic cylinder (106) of the freeze cylinder assembly (105) resulting in very rapid freezing of the droplets.

Sample particles frozen using this method are then recovered using the scraper assembly (109), which allows collection of the product during the freezing process. In certain embodiments, a primary application of the system is to rapidly freeze small droplets of fluid using a very cold target.

According to an embodiment, the freezing roller drum assembly (105) achieves thin film freezing of an active agent. In certain embodiments, the freezing roller drum assembly is configured to cool the system to a target temperature using a circulating cooling gas. As the cooling gas, for example, liquid nitrogen or liquid argon is often used, but another gas suitable for the cooling temperature may be utilized.

In certain embodiments, the freezing roller drum assembly includes a shroud assembly to maintain a more constant internal temperature, to protect against contamination and bioburden and/or particulate matter including viable and non-viable particulates, and to increase overall yield. The process includes initially cooling the system to a desired temperature. The active agent (e.g., a small molecule or biologic agent) is first dissolved or dispersed in one or more solvents followed by spraying or dripping droplets of solvent including the dissolved or dispersed active agent such that the active agent is exposed to a vapor-liquid interface of less than 50, 100, 150, 200, 250, 300, 400 or even 500 cm⁻¹ area/volume; and contacting the droplet with a freezing surface of a freeze cylinder assembly that has a temperature differential of at least about 30° C. between the droplet and the freeze cylinder assembly surface. In certain embodiments, the temperature differential between the droplet and the freeze cylinder assembly surface is at least about 10° C., 20° C., 30° C., 40° C., or 50° C.

In certain embodiments, the cryogenic surface freezes the droplet into a thin film with a thickness of less than 500 micrometers and a surface area to volume between 25 to 500 cm⁻¹. In certain embodiments, the surface freezes the droplet into a thin film with a thickness of less than 500 micrometers, less than 400 micrometers, less than 300 micrometers, less than 200 micrometers, less than 100 micrometers, less than 50 micrometers, less than 25 micrometers, less than 10 micrometers, or less than 1 micrometer.

In certain embodiments, the surface freezes the droplet into a thin film with a surface area to volume between about 25 to 500 cm⁻¹, about 50 to 400 cm⁻¹, about 75 to 300 cm⁻¹, or about 100 to 200 cm⁻¹. In certain embodiments, the surface freezes the droplet into a thin film with a surface area to volume of less than about 500 cm⁻¹, about 450 cm⁻¹, about 400 cm⁻¹, about 350 cm⁻¹, about 300 cm⁻¹, about 250 cm⁻¹, about 200 cm⁻¹, about 150 cm⁻¹, about 100 cm⁻¹, or less than about 50 cm⁻¹.

In one embodiment, the method further includes the step of removing the solvent from the frozen material to form particles. In one embodiment, the droplets freeze upon contact with the surface in about 10, 20, 30, 40, 50, 75, 100, 125, 150, 175, 200, 250, 500, 1,000 and 2,000 milliseconds. In another embodiment, the droplets freeze upon contact with the surface in about 50 and 150 milliseconds. In another embodiment, the droplet has a diameter between 1 and 500 μm at room temperature. In another embodiment, the droplet forms a thin film on the surface of between 10 and 500 micrometers in thickness.

In another embodiment, the droplets have a cooling rate of between about 50 and about 250° C./s, between about 100 and about 200° C./s, between about 150 and about 175° C./s, between about 160 and about 170° C./s,

In another embodiment, the particles after solvent removal have a surface area of about 10 m²/gr, 15, 25, 50, 75, 100, 125, 150 or about 200 m²/gr.

In one embodiment, the droplet includes an active agent, for example, a small molecule active agent or biological agent, and the particle has less than 50% of the active agent at the particle surface. The active agent particle has less than about 25, 15, 10 or 5% of the active agent at the surface. In another embodiment, the particles are submicron in diameter and may include particle fibers less than one micron in diameter.

In one embodiment, the surface is cooled by a cryogenic solid, a cryogenic gas, a cryogenic liquid or a heat transfer fluid capable of reaching cryogenic temperatures or temperatures below the freezing point of the solvent. In another aspect, the solvent further includes one or more excipients selected from sugars, phospholipids, surfactants, polymeric surfactants, vesicles, polymers, including copolymers and homopolymers and biopolymers, dispersion aids, and serum albumin.

In various embodiments, the percentage of active agent in a pharmaceutically acceptable excipient is from about 0.1% to about 100%. In various embodiments, the percentage of active agent in a pharmaceutically acceptable excipient is about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, 99.9, or about 100%.

In certain embodiments, the freeze cylinder assembly is mounted, for example, within the system. In addition to cooling the freeze cylinder assembly, the collection assembly is also cooled using, for example dry ice, liquid nitrogen, or other appropriate means.

In certain embodiments, the target cooling temperature is a desired cryogenic temperature selected from a temperature range from a predetermined lower limit temperature to a predetermined upper limit temperature. The lower limit temperature is, for example, a lowest temperature at which cooling can be made by the cryogenic cooling system, and may be, for example, −170° C. The upper limit temperature is, for example, a desired cryogenic temperature determined in accordance with a material to be used, but is, for example, a liquid nitrogen temperature or lower, or a cryogenic temperature of about −50° C., about −60° C., about −70° C., about −80° C., about −90° C., about −100° C., about −110° C., about −120° C., about −130° C., about −130° C., about −140° C., about −150° C., about −160° C., or about −170° C.

In various embodiments, the cryogenic system includes a freezing roller drum assembly, and the freezing roller drum assembly further includes a shroud system that maintains a constant temperature, desiccates the local ambient environment, reduces bioburden and particulate matter including viable and non-viable particulates, and increases yield of the active agent.

In certain embodiments, the cryogenic cooling system optionally includes a cryocooler that continuously cools the cooling gas of the cryogenic cooling system. In other embodiments, the cryogenic cooling system optionally includes a gas supply line, and/or the gas recovery line including one or more flexible or rigid pipes.

In certain embodiments, the gas flow path is provided around or inside the freezing roller drum assembly to be cooled by flowing the cooling gas. The cold gas flow path includes an inlet and an outlet. The gas supply line is connected to the inlet of the gas flow path, and the gas recovery line is connected to the outlet of the cooled gas flow path. Therefore, the cooling gas flows into the gas pipe from the gas supply line through the inlet, and further flows out from the gas pipe through the outlet to the gas recovery line.

In certain embodiments, the freezing roller drum assembly includes a product inlet (204) that allows product to enter a plurality of product inlet tubes (206), which then provides a plurality of drops onto the freezing cylinder assembly to allow the active agent dissolved or dispersed in solvent to contact (e.g., by dripping or spraying) the freeze cylinder assembly (105) and freeze onto the cryogenic cylinder (106) surface. The frozen product is then scraped off (109) of the freeze cylinder assembly and deposited in a collection tray (111), which is under constant or steady temperature.

In certain embodiments, neither the gas supply line nor the gas recovery line is in physical contact with the active agent to be cooled. The gas supply line extends in a direction toward the pharmaceutical or biologic agent to be cooled from the inlet, and the gas recovery line extends in the direction away from in the active agent to be cooled from the outlet.

In certain embodiments, the system of the invention may also optionally include a heat exchanger. The heat exchanger is configured such that the cooling gases flowing through the gas supply line and the gas recovery line exchange heat with each other between the gas supply line and the gas recovery line. The heat exchanger helps improve the cooling efficiency of the cryogenic cooling system.

In certain embodiments, the cryogenic system can be operated at ambient, positive or negative atmospheric pressure.

In certain embodiments, the cryogenic system includes one or more sensors, for example, a temperature sensor. The temperature sensor may be installed at any location in the cooling gas flow path including the gas flow path. In addition, a plurality of the temperature sensors may be installed at different locations in or around the cooling gas flow path.

In certain embodiments, the cryogenic cooling system includes a control device that controls the cryogenic cooling system. The control device includes a gas flow rate control unit. The gas flow rate control unit includes a timer and an initial cooling setting. The control device is disposed in the surrounding environment. The control device may be installed in the gas circulation source, for example, the compressor.

In certain embodiments, the control device of the cryogenic cooling system is realized by elements and circuits including a CPU and memory of a computer as a hardware configuration and realized by a computer program or the like as a software configuration.

In certain exemplary embodiments, when using an enclosure, the initial cooling of the enclosure system is the control processing of the cryogenic system that rapidly cools both the enclosure and the freeze roller drum assembly (101) to be cooled from the room temperature to the target cooling temperature, and is performed when the cryogenic cooling system is activated. By the initial cooling, the enclosure and freeze cylinder assembly are cooled from room temperature to the target cooling temperature. After the completion of the initial cooling, the cryogenic system transits to the steady cooling for maintaining the enclosure and freeze cylinder assembly at the target cooling temperature. In certain embodiments, the temperature lowering rate in the initial cooling is higher than the temperature lowering rate in the steady cooling.

The control device is configured to start the initial cooling of the enclosure and freeze cylinder assembly in synchronization with the activation of the cryogenic system. For example, the control device starts the initial cooling of the freeze cylinder assembly to be cooled at the same time as the activation of the cryogenic cooling system or when a predetermined delay time has elapsed from the activation time point of the cryogenic cooling system.

Typically, the activation of the cryogenic cooling system means the activation of the gas circulation source. Therefore, the control device may be configured to start the initial cooling of the object to be cooled in synchronization with the activation of the gas circulation source. Alternatively, the control device may be configured to start the initial cooling in synchronization with the activation of the gas circulation source.

In certain embodiments, the cryogenic cooling system includes a main switch. The main switch includes an operation tool such as an operation button or switch that can be manually operated, and is configured to output a system activation command signal to the control device when operated. When a technician operates the main switch, the cryogenic system is activated and its operation is started. The main switch may function not only as an activation switch of the cryogenic cooling system, but also as a stop switch of the cryogenic cooling system.

The main switch may be installed in the control device or its casing. Alternatively, in a case where a higher-level control device is provided separately from the control device, the higher-level control device may be configured to output the system activation command signal to the control device.

The control device is configured to start initial cooling in accordance with the received system activation command signal. The control device is configured to control the gas circulation source so as to execute the initial cooling of the object to be cooled. During the initial cooling, the control device controls the gas circulation source such that the cooling gas flows through the cooling gas flow path according to a prescribed flow rate pattern. The control device may control the gas circulation source so as to execute the steady cooling of the object to be cooled after the initial cooling or at other appropriate timing.

The gas or gas/liquid mixture flow rate control unit is configured to determine the target cooling gas flow rate on the basis of the initial cooling setting and the elapsed time from the start of the initial cooling. The gas flow rate control unit is configured to control the gas circulation source such that the cooling gas flows through the cooling gas flow path at the determined target cooling gas flow rate. The gas flow rate control unit is configured to generate the gas circulation source control signal such that the cooling gas is delivered to the cooling gas flow path at the target cooling gas flow rate by the gas circulation source, and outputs the gas circulation source control signal to the gas circulation source.

In certain embodiments, a timer is configured to measure the elapsed time. The timer is configured to measure the elapsed time in accordance with the system activation command signal. The timer can calculate the elapsed time from the start of the initial cooling.

The initial cooling setting predetermines the target cooling gas flow rate at each time from the start to the completion of the initial cooling according to the prescribed flow rate pattern. The initial cooling setting may have a function, a look-up table, a map, or another format representing a correspondence relationship between the elapsed time and the target cooling gas flow rate.

The target cooling gas flow rate is set, for example, such that the cryogenic cooling system provides sufficient cooling capacity to cool the object to be cooled to the target temperature. The target cooling gas flow rate can be appropriately set for each cooling temperature on the basis of a designer's empirical knowledge or designer's experiments and simulations.

It is convenient to express the cooling gas flow rate as a mass flow rate. As is known, since the mass flow rate is constant at each location of the cooling gas flow path, the cooling gas flow rate delivered from the gas circulation source is equal to the cooling gas flow rate flowing through the freeze cylinder assembly gas flow path. However, when applicable, the flow rate pattern may be described as a relationship between the volume flow rate and other flow rates and time.

In certain embodiments, the fixed flow rate may be referred to as a cooling gas flow rate for maximizing the cooling capacity of the cryogenic cooling system at a target cooling temperature in the steady cooling and an optimal flow rate. The steady operation cooling temperature typically coincides with the target cooling temperature in the initial cooling.

In certain embodiments, the cryogenic system includes a source of liquid nitrogen (not shown), optionally a cryogenic heat exchanger, and an exhaust or vent line. Liquid nitrogen at cryogenic temperatures is supplied to the cryogenic system to maintain a steady temperature in the enclosure system. After transferring most of its refrigeration capacity to the freeze cylinder assembly, the residual nitrogen gas is exhausted via a vent line. In some applications, it may be possible to utilize the vented nitrogen gas in some other cooling application or to recycle the gas.

In certain embodiments, the freezer roller drum assembly with the shroud (See FIG. 1) includes a plurality of circulating loops including exit orifices (206) from the product inlet (204) fed from the manifold assembly through the shroud cover (202).

During this freezing phase, the cryogenic refrigeration system holds the temperature of the cryogenic cylinder at the prescribed temperature continuously to ensure the products are frozen completely. The exact temperature set point during this freezing phase may vary depending on the active agent to be frozen and solvent system utilized.

### Methods of Use

The invention includes compositions and method for preparing micron-sized or submicron-sized particles by dissolving or dispersing an active agent and one or more excipients in one or more solvents; spraying or dripping droplets solvent such that the active agent is exposed to an vapor-liquid interface of less than about 50, 100, 150, 200, 250, 300, 400 or even 500 cm⁻¹ area/volume; and contacting or dispersing the droplet into a freezing surface that has a temperature differential of at least 30° C. between the droplet and the surface, wherein the surface freezes the droplet into a thin film with a thickness of less than 500 micrometers and a surface area to volume between about 25 to about 500 cm⁻¹.

In one embodiment, the method further includes the step of removing the solvent from the frozen material to form particles. In another embodiment, the droplets freeze upon contact with the surface in about 50, 75, 100, 125, 150, 175, 200, 250, 500, 1,000 and 2,000 milliseconds. In another aspect, the droplets freeze upon contact with the surface in about 50 and 150 milliseconds. In another aspect, the droplet has a diameter between 2 and 5 mm at room temperature. In another aspect, the droplet forms a thin film on the surface of between 50 and 500 micrometers in thickness. In another aspect, the droplets have a cooling rate of between 50-250° C./s. In another aspect, the particles after solvent removal have a surface area of 10, 15, 25, 50, 75, 100, 125, 150 or 200 m²/gr.

Another embodiment of the present invention includes a method for preparing micron-sized or submicron-sized solvent particles including: spraying or dripping droplets of an active agent and optionally one or more excipients in an aqueous or organic solvent or solvents, wherein the droplet is exposed to an vapor-liquid interface of less than 50 cm⁻¹ area/volume; contacting the droplet with a freezing surface that has a temperature differential of at least 30° C. between the droplet and the surface, wherein the droplet freezes into a thin film with a thickness of less than 500 micrometers and a surface area to volume between 25 to 500 cm⁻¹. The method may further include the step of removing the solvent from the frozen material to form particles

In one embodiment, the invention includes a formulation (e.g., an active agent) that includes particles prepared using the cryogenic freezing system that are micron-sized or submicron-sized solvent particles including: spraying or dripping droplets of an active agent and one or more excipients in a solvent or solvents, wherein the droplet is exposed to an vapor-liquid interface of less than 50 cm⁻¹ area/volume; contacting the droplet with a freezing surface that has a temperature differential of at least 30° C. between the droplet and the surface, wherein the droplet freezes into a thin film with a thickness of less than 500 micrometers and a surface area to volume between 25 to 500 cm⁻¹.

Yet another embodiment includes compositions and methods for preparing micron-sized or submicron-sized particles by preparing an emulsion including a water soluble active agent in solution; spraying or dripping droplets of the solution such that the active agent is exposed to an vapor-liquid interface of less than 50 cm⁻¹ area/volume; and contacting the droplet with a freezing surface that has a temperature differential of at least 30° C. between the droplet and the surface, wherein the surface freezes the droplet into a thin film with a thickness of less than 500 micrometers and a surface area to volume between 25 to 500 cm⁻¹.

Yet another embodiment includes a system for preparing solvent nano- and micro-particles that includes a solvent source composed of one or more solvents; a vessel containing a cryogenic liquid selected from cryogenic liquid selected from the group consisting of carbon dioxide, nitrogen, ethane, propane, helium, argon, or isopentane; and an insulating nozzle having an end and a tip, wherein the end of the nozzle is connected to the solvent source and the tip is placed above, at or below the level of the cryogenic liquid. In one aspect, the solution source further includes water, at least one organic solvent, or a combination thereof. In one aspect, the organic solvent is elected from the group consisting of ethanol, methanol, tetrahydrofuran, acetonitrile, acetone, tert-butyl alcohol, dimethyl sulfoxide, N,N-dimethyl formamide, diethyl ether, methylene chloride, ethyl acetate, isopropyl acetate, butyl acetate, propyl acetate, toluene, hexanes, heptane, pentane, and combinations thereof.

In another embodiment, a method for spray freezing includes spraying a solvent including active agent through an insulating nozzle, wherein the spray rapidly generates frozen solvent particles having a size range of 1 nm to 10 microns. In one aspect, the solvent particles produced have a particle size of less than 10 microns. In another aspect, the solvent particle has a surface area greater than 50 m²/g. In one aspect, the cryogenic material is a liquid, a gas, a solid or a surface. In another aspect, the one or more solvents comprises a first solvent that is less volatile than a second solvent, wherein the more volatile solvent is removed but not the second solvent. In yet another aspect, the one or more solvents comprises a first solvent that is less volatile than a second solvent, wherein the more volatile solvent is removed by evaporation, sublimation, lyophilization, vacuum, heat or chemically.

Yet another embodiment of the invention includes a single-step, single-vial method for preparing micron-sized or submicron-sized particles by reducing the temperature of a vial wherein the vial has a temperature differential of at least 30° C. between the solvent and the vial and spraying or dripping droplets of an active agent and one or more excipients dissolved or dispersed in a solvent or solvents directly into the vial such that the active agent is exposed to a vapor-liquid interface of less than 500 cm⁻¹ area/volume, wherein the surface freezes the droplet into a thin film with a thickness of less than 500 micrometers and a surface area to volume between 25 to 500 cm⁻¹. The droplets freeze may upon contact with the surface in about 50, 75, 100, 125, 150, 175, 200, 250, 500, 1,000 and 2,000 milliseconds, and may even freeze upon contact with the surface in about 50, 150 to 500 milliseconds. In one example, a droplet has a diameter between 0.1 and 5 mm at room temperature or even a diameter between 2 and 4 mm at room temperature. In another example, the droplet forms a thin film on the surface of between 50 and 500 micrometers in thickness. In one specific example the droplets will have a cooling rate of between about 50 and about 250° C./s. The vial may be cooled by a cryogenic solid, a cryogenic gas, a cryogenic liquid, a freezing fluid, a freezing gas, a freezing solid, a heat exchanger, or a heat transfer fluid capable of reaching cryogenic temperatures or temperatures below the freezing point of the solvent. The vial may even be rotated as the spraying or droplets are delivered to permit the layering or one or more layers of the final particles. In one example, the vial, including the active agent and the one or more solvents are pre-sterilized prior to spraying or dripping. The method may also include the step of spraying or dripping is repeated to overlay one or more thin films on top of each other to fill the vial to any desired level up to totally full.

The ability to produce high surface area stable submicron and micron-sized protein particles would create new opportunities for oral, depot, pulmonary, injectable, and transdermal delivery applications. In pulmonary delivery, high surface area porous particles with aerodynamic diameters between about 1 and about 3 m may be deposited more efficiently in the deep lung compared to dense particles with similar aerodynamic diameters. In depot delivery, about 300 to about 500 nm submicron active agent particles have been encapsulated uniformly into about 10 to about 50 m diameter microspheres to achieve high loadings.

### Compositions of the Invention

The pharmaceutically acceptable carrier can be used optionally with all active agents, and can include any and all solvents. The use of such media and agents for pharmaceutical active substances is well known in the art. Supplementary active ingredients can also be incorporated into the compositions.

In certain embodiments, pharmaceutical compositions may comprise, for example, at least about 0.1% of an active agent. In other embodiments, the active agent may comprise between about 0.1% to about 99.9% of the total weight of the composition depending on product. In various embodiments, the percentage of active agent in a composition (w/w) is about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or about 99.9%.

In other non-limiting examples, a dose may also comprise from about 1 microgram/kg/body weight, about 5 microgram/kg/body weight, about 10 microgram/kg/body weight, about 50 microgram/kg/body weight, about 100 microgram/kg/body weight, about 200 microgram/kg/body weight, about 350 microgram/kg/body weight, about 500 microgram/kg/body weight, about 1 milligram/kg/body weight, about 5 milligram/kg/body weight, about 10 milligram/kg/body weight, about 50 milligram/kg/body weight, about 100 milligram/kg/body weight, about 200 milligram/kg/body weight, about 350 milligram/kg/body weight, about 500 milligram/kg/body weight, to about 1000 mg/kg/body weight or more per administration, and any range derivable therein. In non-limiting examples of a derivable range from the numbers listed herein, a range of about 5 mg/kg/body weight to about 100 mg/kg/body weight, about 5 microgram/kg/body weight to about 500 milligram/kg/body weight, etc., can be administered, based on the numbers described above.

The active agents may be used in a variety of application modalities, including oral delivery as tablets, capsules or suspensions; pulmonary and nasal delivery; topical delivery as emulsions, ointments or creams; and parenteral delivery as suspensions, solutions, microemulsions or depot. The resulting powder can be redispersed at any convenient time into a suitable aqueous medium such as saline, buffered saline, water, buffered aqueous media, solutions of amino acids, solutions of vitamins, solutions of carbohydrates, or the like, as well as combinations of any two or more thereof, to obtain a suspension that can be administered to mammals.

The solvent can be an aqueous such as water, one or more organic solvents, or a combination thereof. When used, the organic solvents can be water miscible or non-water miscible. Suitable organic solvents include, but are not limited to, ethanol, methanol, tetrahydrofuran, acetonitrile, acetone, tert-butyl alcohol, dimethyl sulfoxide, N,N-dimethyl formamide, diethyl ether, methylene chloride, ethyl acetate, isopropyl acetate, butyl acetate, propyl acetate, toluene, hexanes, heptane, pentane, and combinations thereof.

Excipients and adjuvants may be used in the present invention, while potentially having some activity in their own right, for example, antioxidants, are generally defined for this application as compounds that enhance the efficiency and/or efficacy of the active agents. It is also possible to have more than one active agent in a given solution, so that the particles formed contain more than one active agent.

As stated, excipients and adjuvants may be used to enhance the efficacy and efficiency of the active agents. Non-limiting examples of adjuvants that can be included in the solutions including the active agents that are to be dropped or dispersed in accordance with the present invention include, but not limited to, cryoprotectants, lyoprotectants, surfactants, fillers, stabilizers, polymers, protease inhibitors, antioxidants and absorption enhancers. The excipients may be chosen to modify the intended function of the active agent by improving flow, or bio-availability, or to control or delay the release of the active agent. Specific nonlimiting examples include sucrose, trehaolose, Span 80, Tween 80, Brij 35, Brij 98, Pluronic, sucroester 7, sucroester 11, sucroester 15, sodium lauryl sulfate, oleic acid, laureth-9, laureth-8, lauric acid, vitamin E TPGS, Gelucire 50/13, Gelucire 53/10, Labrafil, dipalmitoyl phosphatidyl choline, glycolic acid and salts, deoxycholic acid and salts, sodium fusidate, cyclodextrins, polyethylene glycols, labrasol, polyvinyl alcohols, polyvinyl pyrrolidones and tyloxapol. Using the process of the present invention, the morphology of the active agents can be modified, resulting in highly porous microparticles and nanoparticles.

In certain embodiments, the invention demonstrates a novel method to produce stable submicron particles. The thin film freezing methods comprise liquid droplets typically falling from a given height and impacting, spreading, and freezing on a cooled solid substrate. In various embodiments, a droplet falls from a given height and impacts a spinning surface that has a temperature of about −50° C., −70° C., −90° C., −110° C., −130° C., or about −150° C. Typically, the size of the completely frozen droplet is about 10 μm in diameter, with a height approximately 200 m. In various embodiments, the spinning surface of the cryogenic cylinder (106) spins at a rate of about 3 rotations per minute (rpm), 5 rpm, 6 rpm, 7 rpm, 8 rpm, 9 rpm, 10 rpm, 11 rpm, 12 rpm, 13 rpm, 14 rpm, 15 rpm, 16 rpm, 17 rpm, 18 rpm, 19 rpm, 20 rpm, 25 rpm, or 30 rpm.

As will be apparent to those of skill in the art, the droplets may be delivered to the cold or freezing surface in a variety of manners and configurations. For example, to provide for high-throughput capabilities, the droplets may be delivered in parallel, in series, at the center, middle or periphery or a platen, platter, plate, roller, conveyor surface. The freezing or cold surface may be a roller, a belt, a solid surface, circular, cylindrical, conical, oval and the like that permit for the droplet to freeze. For a continuous process a belt, platen, plate or roller may be particularly useful. In operation, frozen droplets may form beads, strings, films or lines of frozen substrate and active agent that are removed from the surface with a scraper, wire, ultrasound or other mechanical separator prior to the lyophilization process. Once the material is removed from the surface of the belt, platen, roller or plate the surface is free to receive additional material in a continuous process.

After the frozen particles are scraped off the cryogenic cylinder and collected, solvent may be removed by sublimation to provide the final particles.

Delivery of the final particles can be achieved through any suitable delivery means. For example, for inhalation delivery this can include a nebulizer, a dry powder inhaler, or a metered dose inhaler. The most suitable delivery means will depend upon the active agent to be delivered, the desired effective amount for that active agent, and characteristics specific to a given patient.

### EXAMPLES

### Example 1

Exemplary Embodiments of the Thin Film Freezing (TFF) procedure.

Aqueous solutions of an active agent are passed at a flow rate of 4 mL/min either through a 17 gauge (1.1 mm ID, 1.5 mm OD) stainless steel syringe needle producing 3.6 mm diameter droplets or through 3.9 mm ID, 6.4 mm OD stainless steel tubing producing 5.6 mm diameter droplets. The droplets fall from a height of 10 cm above a rotating stainless steel drum 17 cm long and 12 cm in diameter. The stainless steel drum is hollow with 0.7 cm thick walls and is filled with dry ice or liquid nitrogen to maintain drum surface temperatures of approximately −90° C. or −110° C., respectively. Before each run, the surface temperature of the drum is verified with a DiGi-Sense® Type K thermometer using a 450 angle surface probe thermocouple attachment (Eutech Instruments). The drum rotated at approximately 12-20 rpm and is powered by a Heidolph RZR2041 mechanical overhead stirrer (ESSLAB) connected to a speed reducer. On impact the droplets deform into thin films and freeze. The frozen thin films are removed from the drum by a stainless steel blade mounted along the rotating drum surface. The frozen thin films then fell 5 cm into a 400 mL Pyrex® beaker filled with liquid nitrogen.

Drying and Shelf Loading

A Virtis Advantage Lyophilizer (The Virtis Company, Inc.) is used to dry the frozen slurries. The 400 mL beakers containing frozen slurries are covered with a single layer Kim-wipe. Primary drying was carried out at −40° C. for 36 hrs. at 300 mTorr and secondary drying at 25° C. for 24 hrs at 100 mTorr. A 12 hour linear ramp of the shelf temperature from −40° C. to +25° C. was used at 100 mTorr.

Transfer and storage of dried powders. After the lyophilization cycle was complete, the lyophilizer was purged with nitrogen upon releasing the vacuum to reduce the exposure time of the powders to water vapor in the ambient air before transfer. The samples were then rapidly transferred to a dry box held at 14% RH, and the powders were transferred to 20 mL scintillation vials. The vials were then covered with 24 mm Teflon® Faced Silicone septa (Wheaton) which were held in place by open-top screw cap lids. Vials were purged with dry nitrogen for 2 minutes via a needle through the septa and an additional needle for the gas effluent.

Surface Area Measurement.

Surface areas of dried powders is measured with a Quantachrome Nova 2000 (Quantachrome Corporation) BET apparatus. Dried powders are transferred to the glass BET sample cells in a dry box. Samples are then degassed under vacuum for a minimum of 12 hours. Particle size analysis.

### Example 2

API Formulation

500 g of Active Pharmaceutical Ingredient A are dissolved into 6.84 kgs of Acetonitrile in a 10L Stainless steel vessel under vortex mixing. 30 g of Excipient B is dissolved into 8.8 kgs of water for injection in a second 10L Stainless steel vessel under vortex mixing. The contents of SS vessel #1 and SS vessel #2 are then transferred into a 20L SS nitrogen blanketed and ground vessel and homogenously mixed using an integrated overhead vessel mixer.

Continuous Thin-Film Freezing

This API/Excipient mixture dissolved in a water-acetonitrile solvent mixture is then pumped at a flow rate of 50 ml/min through a manifold of tubing orifices with 0.838 mm IDs that each produce a continuous stream of discrete droplets (3-5 mm in diameter). The tubing manifold is positioned directly above the rotating freeze cylinder assembly with a distance of 8 cm between the surface of the cylinder and the exit of the manifold orifices.

These droplets continuously fall and freeze rapidly upon contact with the cryogenically cooled surface of the rotating freeze cylinder assembly. The cylinder rotates at 20 RPMs and frozen droplets are continuously removed by the fixed scraper blade assembly and allowed to drop into cooled collection trays. This also ensures a continuously regenerated and fresh freezing surface is available for the continuously produced drug product droplets.

The surface of the freezer cylinder assembly is maintained at −130° C.±20° C. during the entire production run by controlling the feed of cryogenic liquid to the drum based on real-time surface temperature read-out using a DiGi-Sense® Type K thermometer with a direct contact thermocouple probe.

Lyophilization

Once the entire batch has been frozen and collected into trays those trays are then loaded into a 15 shelf Virtis Ultra lyophilizer pre-cooled to −60° C. shelf temperature. Once all trays have been loaded the lyophilizer is pumped down to 100 mTorr and held for 300 mins. Primary drying is then carried out at −40° C. for 1200 mins and secondary drying at 25° C. for 2400 mins. After drying is completed TFF processed bulk API and excipient powder is then transferred from the trays into the appropriate secondary bulk containers for further processing and final packaging.

Surface Area Measurement

Surface areas of dried powders are measured with a Quantachrome Nova 2000 (Quantachrome Corporation) BET apparatus. Dried powders are transferred to glass BET sample cells in a dry box. Samples are then degassed under vacuum for a minimum of 12 hours before analysis.

Particle Size Analysis.

The size distribution of dried powders are measured by multiangle laser light scattering with a Malvern Mastersizer-S (Malvern Instruments). A mass of 30-100 mg of powder is suspended in 10 mL of acetonitrile and the suspension is then sonicated on ice for 1 minute using a Branson Sonifier 450 (Branson Ultrasonics Corporation) with a 102 converter and tip operated in pulse mode at 35 W. Typical obscuration values ranged from 11% to 13%. Aliquots of the sonicated suspension were then dispensed into a 500 mL acetonitrile bath for analysis.

### Example 3

API Formulation

6.0 kg of Acetonitrile and 6.0 kg of Tert-butanol are first homogenously mixed in a 20L SS nitrogen blanketed and grounded vessel using an integrated overhead mixer. 20 g of Active Pharmaceutical Ingredient C is then dissolved into this Acetonitrile/Tert-butanol solvent system under vortex mixing conditions. Finally, 750 grams of Excipient D, which is not soluble in Acetonitrile/Tert-butanol, is then added slowly to the same 20L vessel under slight vortex conditions creating a well-mixed slurry. A slight vortex is maintained during the entire TFF processing of this material to ensure a uniform slurry is present while also minimizing any slurry particle attrition over time.

Continuous Thin-Film Freezing

This API/Excipient slurry dispersed in a acetonitrile/tert-butanol solvent mixture is then pumped at a flow rate of 50 ml/min through a manifold of tubing orifices with 0.838 mm IDs that each produce a continuous stream of discrete droplets (3-5 mm in diameter). The tubing manifold is positioned directly above the rotating freeze cylinder assembly with a distance of 8 cm between the surface of the cylinder and the exit of the manifold orifices.

These droplets continuously fall and freeze rapidly upon contact with the cryogenically cooled surface of the rotating freeze cylinder assembly. The cylinder rotates at 20 RPMs and frozen droplets are continuously removed by the fixed scraper blade assembly and allowed to drop into cooled collection trays. This also ensures a continuously regenerated and fresh freezing surface is available for the continuously produced drug product droplets.

The surface of the freezer cylinder assembly is maintained at −130° C.±20° C. during the entire production run by controlling the feed of cryogenic liquid to the drum based on real-time surface temperature read-out using a DiGi-Sense® Type K thermometer with a direct contact thermocouple probe.

Lyophilization

Once the entire batch has been frozen and collected into trays those trays are then loaded into a 15 shelf Virtis Ultra lyophilizer pre-cooled to −60° C. shelf temperature. Once all trays have been loaded the lyophilizer is pumped down to 100 mTorr and held for 300 mins. Primary drying is then carried out at −40° C. for 1200 mins and secondary drying at 25° C. for 2400 mins. After drying is completed TFF processed bulk API and excipient powder is then transferred from the trays into the appropriate secondary bulk containers for further processing and final packaging.

Surface Area Measurement

Surface areas of dried powders are measured with a Quantachrome Nova 2000 (Quantachrome Corporation) BET apparatus. Dried powders are transferred to glass BET sample cells in a dry box. Samples are then degassed under vacuum for a minimum of 12 hours before analysis.

Particle Size Analysis.

The size distribution of dried powders are measured by multiangle laser light scattering with a Malvern Mastersizer-S (Malvern Instruments). A mass of 30-100 mg of powder is suspended in 10 mL of acetonitrile and the suspension is then sonicated on ice for 1 minute using a Branson Sonifier 450 (Branson Ultrasonics Corporation) with a 102 converter and tip operated in pulse mode at 35 W. Typical obscuration values ranged from 11% to 13%. Aliquots of the sonicated suspension were then dispensed into a 500 mL acetonitrile bath for analysis.

While the present invention has been specifically described with respect to separation and recovery of carbon dioxide, it will be appreciated that the present invention may be readily used to separate other gases.

It is to be understood that, although prior art use and publications may be referred to herein, such reference does not constitute an admission that any of these form a part of the common general knowledge in the art, in Australia or any other country.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

What is claimed is:

1. A system for thin film freezing of an active agent or a composition comprising:
(i) a freezing roller drum assembly, comprising:
(1) a freeze cylinder assembly;
(2) a scraper assembly;
(3) a frame assembly;
(4) a motor assembly; and
(5) a manifold assembly,
wherein the freeze cylinder assembly is maintained at a temperature of below −50° C.

2. The system of claim 1 further comprising a shroud covering at least a portion of each of assemblies (1)-(5).

3. The system of claim 2, wherein at least a portion of the shroud is a double-paned shroud.

4. The system of claim 1 further comprising at least one gas plenum to allow a cryogenic liquid, a cryogenic gas, or a heat transfer fluid to circulate within the system.

5. The system of claim 1, wherein the cryogenic source is a cryogenic solid, a cryogenic gas, a cryogenic liquid, or a heat transfer fluid capable of maintaining temperatures below −50° C.

6. The system of claim 4, further including a filter or filtration system to filter a cryogenic source entering the shroud to reduce or remove viable and non-viable particulates from entering the system.

7. The system of claim 1, wherein the cryogenic solid, cryogenic gas, cryogenic liquid, or heat transfer fluid is capable of maintaining temperatures below −50° C.

8. The system of claim 1, wherein a cryogenic gas contacts the freezing cylinder assembly to maintain a temperature below −50° C.

9. The system of claim 1, wherein a cryogenic liquid contacts the freezing cylinder assembly to maintain a temperature below −50° C.

10. The system of claim 1, further comprising a heat exchanger to maintain a temperature below −50° C.

11. The system of claim 4, wherein the cryogenic liquid is an inert liquified gas.

12. The system of claim 11, wherein the inert liquid gas is liquified helium, liquified nitrogen, or liquified argon, or combinations thereof.

13. The system of claim 5, wherein the cryogenic source is dry ice.

14. The system of claim 1, wherein the active agent or composition comprises a small molecule active agent or biologic active agent.

15. A system for thin film freezing of an active agent or composition comprising:
(i) a freezing roller drum assembly comprising:
(1) a freeze cylinder assembly;
(2) a scraper assembly;
(3) a frame assembly;
(4) a motor assembly;
(5) a manifold assembly; and
(6) a shroud covering at least a portion of each of assemblies (1)-(5),
wherein the freezing cylinder assembly is maintained at a temperature of below −50° C.

16. The system of claim 15, wherein at least a portion of the shroud is a double-paned shroud.

17. The system of claim 17, wherein the freezing cylinder assembly is maintained at a temperature of below −50° C. using a cryogenic source.

18. The system of claim 17 further comprising at least one gas plenum to allow a cryogenic source to circulate in the system.

19. The system of claim 17, wherein the cryogenic source is a cryogenic solid, a cryogenic gas, a cryogenic liquid, or a heat transfer fluid capable of maintaining cryogenic temperatures.

20. A method for thin film freezing of an active agent or a composition comprising:
(a) utilizing the system of claim 1, the method comprising:
(i) cooling a surface of a freeze cylinder assembly to a temperature below −50° C.;
(ii) dissolving or dispersing an active agent or composition into a liquid carrier to form an intermediate liquid mixture;
(iii) contacting the intermediate liquid mixture comprising the active agent or composition with the freeze cylinder assembly to freeze the intermediate mixture
